(19) United States
(12) Patent Application Publication
(10) Pub. No.: US 2014/0072481 A1
(43) Pub. Date: Mar. 13, 2014

(54) CATALYTIC STATIC MIXING REACTOR

(71) Applicant: John Scahill, Pagosa Springs, CO (US)

(72) Inventor: John Scahill, Pagosa Springs, CO (US)

(21) Appl. No.: 13/613,555

(22) Filed: Sep. 13, 2012

(51) Int. Cl. B01J 19/24

(52) U.S. Cl. 422/149; 422/222

(57) ABSTRACT

A catalytic static mixing reactor has a conduit casing defined about an axis of a fluid flow. A catalyst is deposited on a mixing element. The mixing element is adapted to be inserted in the conduit. The element provides an exceptionally high surface area and is formed to obstacle the primary flow inducing a first order mixing phenomenon. The element is formed with at least one irregular surface or edge capable of inducing a second order mixing phenomenon. The irregular surface is adapted as a catalytic supporting surface. The supporting surface supports the deposition of the catalyst thereon so that a third order chemical reaction phenomenon is coupled with that of said first and second order mixing phenomenon at the catalytic surface so that a reactant to be converted in the fluid flow is converted to at least one predetermined product during said first and second order mixing phenomenon.

### CROSS REFERENCE TO RELATED APPLICATIONS

None.

### STATEMENT OF FEDERALLY SPONSERED RESEARCH

None.

### DESCRIPTION OF THE INVENTION

1. Technical Field

The present invention relates to catalytic reactors. In particular, it relates to static mixing catalytic reactors including mixing elements having enhanced surfaces for the deposition of catalytically active chemical compounds.

2. Background Art

Catalytic reactors are well know in the art of chemical engineering. Such reactors include catalyst-pellet-filled tubes in multi-tubular reactors, and multi-tubular wall-coated catalytic reactors referred to as catalytic monolith reactors, such as those widely used in the automotive industry as the catalytic converter component of an exhaust system. To enable conversion of the reactants to a desired product these catalytic reactors require a through mixing of the chemical reactants in either a gaseous or liquid phases.

In addition to ensuring adequate mixing, optimal conversion efficiency of the chemical reactants into a desired product concentration is also achieved by engineering the catalytic reaction in a manner which brings together the desired chemical reactants within the reactor under carefully controlled conditions of temperature, pressure, residence time, and pH. As a result the overall thermodynamics of a system are taken into consideration when engineering a catalytic chemical process with a goal of achieving optimal conversion efficiency.

The catalytic chemical reactions are often referred to as being either exothermic or endothermic whereby the reaction vessel either liberates hear or requires heat to be imparted into the system, respectively. To maintain a desired thermodynamic equilibrium of the reaction temperatures this heat must be transported either out of, or into, the reaction vessel through the use of either jacketed vessels, heat exchangers, or both.

In addition to controlling the thermodynamic parameters of the system certain heterogeneous or homogeneous catalysts are usually added to reacting medium as additional reactants in order to further promote the conversation of the reactants to their predetermined products. As mentioned above, when catalysts are added to the process, it is necessary to achieve adequate contact of the reactants with the catalysts for a specified time period. For example, the desired contact is achieved differently through the use of various reactor designs including those having a stirred tank, fluidized bed, fixed bed, and entrained flow design. In each case, however, the goal is to achieve good mixing quality of the reactants, in the presence of the catalyst, so that conversion efficiency is enhanced. Selection of a specific reactor design is usually dependent on the type of catalyst used, the nature of the chemical reactants, and the saturation of the catalytically active site as a result of the chemical reaction to be catalyzed. Moreover, when the chemical reactants are included with particulate contaminants then certain reactor designs, such as a fixed bed reactor, are incapable of use because of the accumulation of those particulates at the leading or entrance zones of the reactor. Inherent with this type of accumulation are the undesirable process phenomenon well known to those in the art including restrictions in fluid flow, pump failures, and/or pressure drops within the system which ultimately lead to a shutdown of the process and restoration of the system before the process is capable of returning to operation.

In industrial applications medium mixing is typically performed in stirred tank reactors. While stirred tanks are typically confined to a batch type of process, the stirred tank process are easily adapted to include a formulation of the medium to include catalysts. However, for continuous processes static mixing technology has gained wide acceptance in the industry. When taken together with catalytic applications, the use of static mixers to enhance the overall performance of wall-coated catalytic reactors operating in the mass-transfer limited regime has been reported.

Static mixers consist of a number of stationary mixing elements inserted along the direction of fluid flow within pipes or tubes to facilitate intense mixing of the fluids flowing through the pipe or tube. Their basic design includes two primary styles; being either a stacked chevron or alternating twisted ribbon configuration of the elements in a segment of elements inserted into the pipes or tubes. Another such design is disclosed in U.S. patent Ser. No. 6,394,644, to Streiff. There, the element includes a generally ring-shaped support structure, concentric inner and outer, radially spaced, circumferentially extending surfaces, and first and second axially spaced, generally parallel edge surfaces. The saddle elements may be used in a structure which includes four flip-flopped stacked elements.

Each of these three styles have been shown to demonstrate specific advantages relative to the other, and with respect to the particular fluid (gas or liquid) handling characteristics as the medium to be mixed flows through the pipe or tube. In operation, each of the static mixing elements allows, as an obstacle, to divide the flow and to recombine it in a geometric sequence. Static mixers are continuous radial mixing devices and they allow to obtain, basically, a plug flow. As these devices are characterized by short residence time and little back mixing, they can be used when the residence time required, by the operation ranges, is in the order of seconds to minutes. Thus, many industrial applications are now identified where static mixers are used including homogenization, dispersion, emulsifying, gas/liquid and liquid/liquid contacting, co-current mass transfer, heat transfer and chemical reaction applications.

While the foregoing examples illustrate the use of catalytic reactors and static mixing element for use in converting a reaction mixture into a desired product concentration the catalytic reactors of the foregoing art, such as the wall-coated monolithic reactors, remain subject to various inefficiencies resulting from, inter alia, certain degrees of contaminate agglomeration and an inherent decrease in the catalytic activity of the wall-coating over time. While this decrease in the rate of catalytic activity is process dependent it eventually requires an overhaul of the process components in order to renew the catalytic activity to optimal levels of conversion efficiency. It can be appreciated then, that restoration of the process is often a costly and time consuming event requiring at least some shutdown of the entire system. Moreover, with the use of wall-coated monolithic catalytic reactors the catalytic chemical constiments are not easily replaced, or substituted. Thus, what is needed is a catalytic reactor capable of increased conversion efficiency with a wide variety of catalytic chemical compounds, thermodynamic transfer, and thorough mixing, but which is characterized by low cost and case in replacement or substitution of the constituent catalytically active chemical compounds of the system. The present invention satisfies these needs.

### SUMMARY OF THE INVENTION

Accordingly it is an object of the present invention to provide a catalytic reactor having mixing elements characterized with exceptionally high surface areas adapted to support the deposition of a wide variety of catalytically active chemical compounds.

It is another object of the present invention to provide a catalytic reactor having thorough mixing capabilities under thermodynamically controlled conditions.

It is another object of the present invention to provide a catalytic reactor which is capable of heat exchange.

It is another object of the present invention to provide a catalytic reactor having catalytically active mixing elements which are readily removable and easily replaced with freshly regenerated mixing elements for the restoration of catalytic activity over time.

It is another object of the present invention to provide a catalytic reactor having exceptionally high surface area mixing elements including nanoparticle irregular surface areas adapted to support the deposition of the catalytically active chemical compounds.

It is another object of the present invention to provide a catalytic reactor having exceptionally high surface area mixing elements adapted to support the deposition of a variety of catalytically active chemical compounds capable of performing a series of chemical reactions as a medium flows past the mixing elements supporting surfaces.

It is yet another object of the present invention to provide a novel catalytic mixing reactor design characterized by inserting multiple catalytically active ribbon elements within the tubes of a conventional shell and tube heat exchanger.

To overcome the problems associated with the prior art methods, and in accordance with the purpose of the present invention, as embodied and broadly described herein, briefly a catalytic static mixing reactor is provided. The reactor includes a conduit casing, defined about an axis of a fluid flow. A catalyst is deposited on a mixing element. The mixing element is adapted to be inserted in the conduit. The element provides an exceptionally high surface area and is formed to obstacle the primary flow inducing a first order mixing phenomenon. The element is further formed with at least one irregular surface or edge capable of inducing a second order mixing phenomenon. The irregular surface is adapted as a catalytic supporting which supports the formation of the catalyst thereon, so that a third order chemical reaction phenomenon is coupled with that of said first and second order mixing phenomenon, at the catalytic surface, so that a reactant to be converted in the fluid flow is converted to at least one predetermined product during said first and second order mixing phenomenon.

Additional advantages of the present invention will be set forth in part in the description that follows and in part will be obvious from that description or can be learned from practice of the invention. The advantages of the invention can be realized and obtained by the system particularly pointed out in the appended claims.

### BRIEF DESCRIPTIONS OF THE DRAWINGS

The accompanying drawings, which are incorporated in and which constitute a part of the specification, illustrate at least one embodiment of the invention, and together with the description, explain the basic principles of the invention.

FIG. 1 is an schematic illustration of the catalytic static mixing reactor, according to the present invention, where the reactor includes a thick-walled casing portion positioned downstream in a process using a main and an additive fluid flows to be mixed.

FIG. 2 is an isometric representation of catlytic static mixer elements in a web structure configuration. Call out portions of the illustration show examples for the structural configuration of the desired exceptionally high catalyst supporting surfaces including the use of nano particulates, nanostructured membranes, and nanofibers.

FIG. 3 is an isometric view of a preferred embodiment of the present invention where the catalytic static mixing reactor is a heat exchanger casing having an array of exchange tubes with catalytic ribbon elements inserted therein.

### DETAILED DESCRIPTION OF THE INVENTION

Unless specifically defined otherwise, all technical or scientific terms used herein have the same meaning as commonly understood by one of ordinary skill in the art to which this invention belongs.

The phrase “chemical reaction phenomenon” as used herein means any natural phenomenon involving the chemistry of catalytic conversion of a substrate into a product.

“Static elements”, as used according to the present invention, that are placed in a fluid, laminar flow, will impart a relatively uniform shear along their length to the extent permitted by the velocity cross section. In a static mixer, fluids in a conduit flow along stationary elements with a vector component in the same direction as the flow. Consequently, the relative velocities of the fluid and the mixing elements can be relatively constant across the cross section of the flow. Because such relative velocities are relatively constant, in-line mixers using static elements can be predictably sized according to production needs.

As used herein, a “static mixer” or “in-line mixer” is an assembly of one or more segments that mixes or blends a material flowing through a flow conduit by subdividing and recombining the flow. A “segment” is an assembly of “elements” that is inserted in the flow conduit. An “element” is a portion of a segment that divides the material flowing through the flow conduit into at least two streams that are combined with separate streams provided by other elements of the segment downstream thereof so as to mix the streams.

Although any of the methods and materials similar or equivalent to those described herein can be used in the practice or deployment of the present invention, the preferred methods and materials are now described. Reference will now be made in detail to the presently preferred embodiments of the invention, examples of which are illustrated in the accompanying drawings wherein like numerals represent like features of the invention.

Generally, an example of a suitable static mixer is the Sulzer Chemtech SMX mixer for viscous mixing, available from Sulzer Chemtech USA, Deer Park, Tex. A similar device is described in U.S. Pat. No. 5,620,252 (Maurer) issued Apr. 15, 1997 which is hereby incorporated herein by reference. In this type of mixer, flat mixing element bars are positioned in a flow conduit at a constant angle to the conduit axis. The elements are arranged in uniform segments of elements with segments of the elements rotated about the axis within a uniform conduit so as to divide the material flowing through the conduit in a multiplicity of directions.

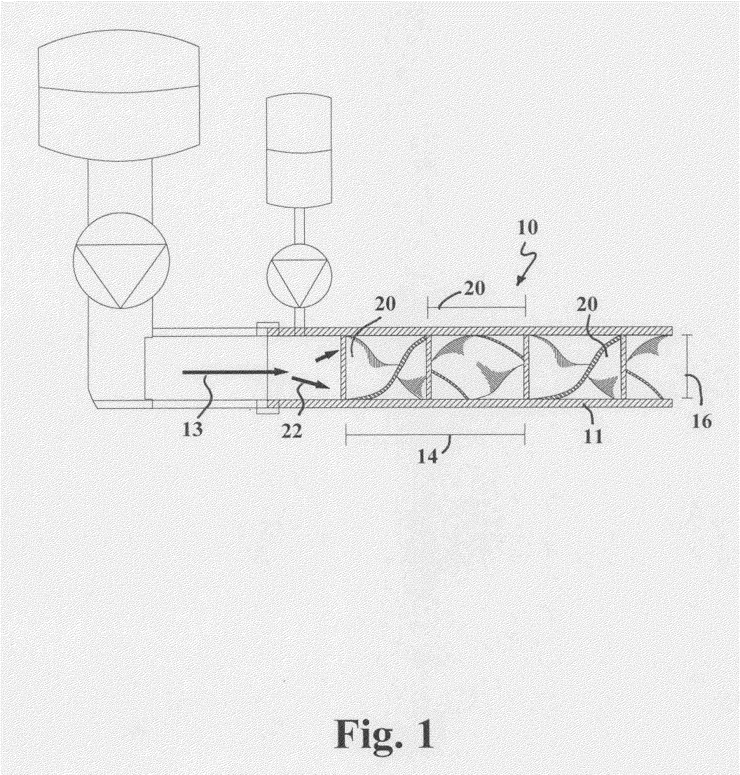

Referring now to FIG. 1, for exemplary purposes, the catalytic static mixing reactor 10 is tailored with respect to element 20 size, element orientation, or conduit 11 cross section, or all of these parameters to provide for varying velocities and shearing forces along the fluid flow axis 13 of the mixer while maintaining a relatively constant forces across the flow. The catalytic static mixing reactor 10 must comprise at least one segment 14, but desirable includes at least two segments that are rotated at an angle relative to each other, such as with those configurations known in the art as having a ribbon or chevron configuration, illustrated in FIG. 1. A preferred angle of rotation is 90 degrees. A segment 14 length approximately equal to the conduit 11 diameter 16 provides particularly desirable mixing properties. Mixers having more than 20 segments 14, typically more than 30 segments are particularly useful. An exemplary mixer has between about 36 and 48 segments 14 wherein each of the segments 14 has a diameter equal to the conduit diameter 16 and a rotational orientation of ninety-degrees, with respect to the segments 14 immediately upstream and downstream thereof.

It is also desirable for some initial premixing 22 of the streams to have occurred prior to entry into the catalytic static mixing reactor 10. This helps insure that portions of both streams are juxtaposed across the cross section of the flow conduit 11. Here, the component parts are in separate streams each having a relatively low viscosity (i.e. the intrinsic viscosity defined by the stream composition). Initially, the streams only experience shear forces very near mixing elements 20. By allowing a brief period of turbulent mixing between the point where the streams are combined and the entry into the first mixer segment 14 provides an initial distribution of both streams across the cross section of the flow conduit 11 so that the streams are more readily subdivided and mixed with each other.

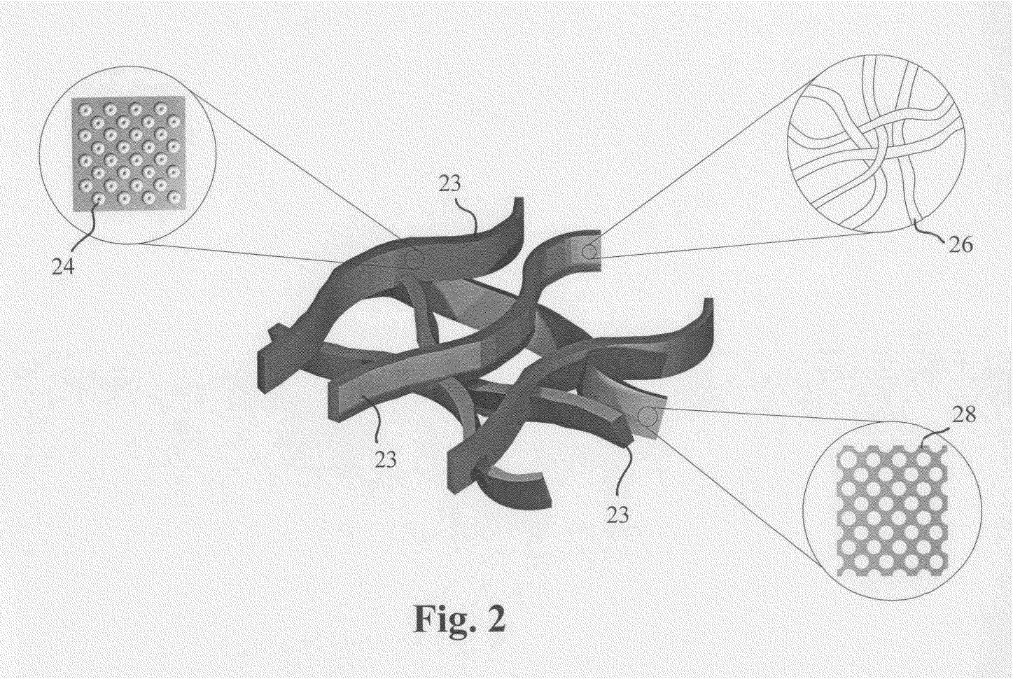

Referring now to FIG. 2, a catalyst is deposited on a mixing element 20. A mixing element 20 can include a number of specific styles or designs, including ribbon, chevron, or the web style elements 23, selected for illustration purposes in the drawing FIG. 2. The techniques described herein can be applied equally to any and all forms and styles of in-line mixing elements. The surfaces 24, 26, 28 of these in-line mixer elements 23 are designed and fabricated to achieve irregular surfaces characterized by yielding exceptionally high surface areas at the microscopic level. The irregular micro surfaces areas 24, 26, 28 are coated with a thin layer of catalytically active materials selected to promote any specific catalytically induced chemical reactions known in the art. Any deposition technique well known in the art is contemplated for use in forming the selected catalyst on the supporting irregular surface of the element 23.

The catalytically active mixing element 23 is adapted to be inserted in the conduit 11. The element 23 provides an exceptionally high surface area and is formed to obstacle the primary flow inducing a first order mixing phenomenon. The element 23 is further formed with at least one surface or edge capable of inducing a second order mixing phenomenon. The element 23 further includes at least one irregular surfaces 24, 26, 28 adapted as a catalytic supporting surface(s). The irregular surface may, but need not, enhance the second order mixing phenomenon. The catalytic supporting surface supports the formation of the catalyst thereon so that a third order chemical reaction phenomenon is coupled with the first and second order mixing phenomenon at the catalytic surface so that a reactant, to be converted in the fluid flow, is converted to at least one predetermined product during mixing.

Recent developments in the field of nano technology have enabled various materials to be fabricated into extremely small (nano) sizes having different fundamental shapes all of which are contemplated as useful in achieving the desired exceptionally high surface area. It is therefore, in at least one preferred embodiment, desired to adapt these materials and techniques to fabricate the static mixing elements 23. Typically, such materials include variations of carbon, alumina, metals and other such materials, which are well know to those of skill in the art, for use in formulating catalyst supports. These nano scale shapes can be spherical particles 24, fibers 26, nanostructured nanomesh catalytic membranes 28, and configured in sheets, tubes, cages or any combinations thereof. It is also possible to fabricate large objects and devices from nano materials using different fabrication techniques such as: 3-D printing, sintering, deposition, compression stamping, and other techniques known to those skilled in the fabrication arts. The static mixing elements 23 desirably include semi-porous surfaces 26, 28 that facilitate both the redirection, in a first order mixing phenomenon, of bulk fluid flow while also enabling a portion of the fluid flow to pass through openings in the macro surface of the element 23 in a second order mixing phenomenon. This design feature is advantageous because it is capable of further increasing the overall exposure of the fluid flow to the enhanced surface area of the status mixing elements 23 catalytic surface(s). Through the application of fluid dynamics one can easily derive the optimal combination of pore size opening(s), pore shape, and total number of pores incorporated into the bulk element surface to effect the desired optimum combination of mixing and chemical reaction phenomenon so that intense mixing coupled with high levels of fluid exposure to the chemical reaction phenomenon is made possible at the mixing surface of the element 23 when exposed to the catalyst.

Various combinations of chemical promoters, such as co-factors, catalytically active reactants, and deposition techniques are contemplated for use with the present invention including. For example, one may vary the specific chemical composition of the catalytically active materials linearly along the substantially longitudinal axis of a mixing element 23 so that a series of sequential chemical reactions is made possible or is carried out upon a series of reaction products in a continuous fluid flow under the same physical conditions.

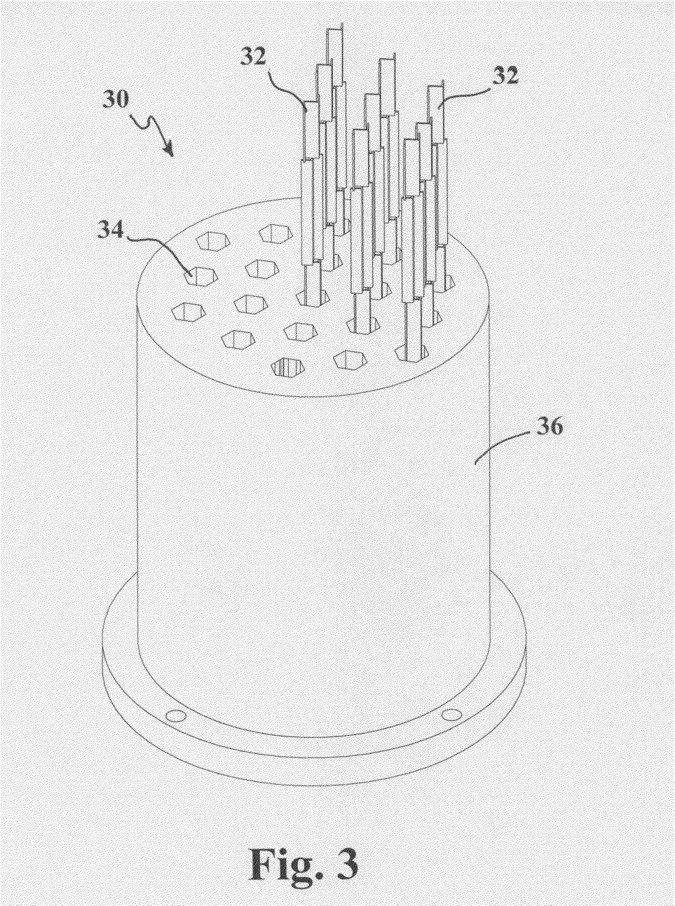

Referring now to FIG. 3, in yet another preferred embodiment of the present invention, a novel catalytic in-line mixer reactor 30 is constructed simply by inserting multiple catalytically active and enhanced surface area static in-line mixer elements 32 within the tubes 34 of conventional shell and tube heat exchanger 36. The catalytically active mixing elements 32 are desirably adapted for replacement, and inserted into the tubes 34 of a conventional shell and tube heat exchanger 36 thereby transforming the heat exchanger 36 it into the catalytic static mixing reactor 30 a novel improvement which imparts significant improvements in the thermodynamic control of the reaction process. In so doing, the static mixing catalytic reactor 30, is capable of readily achieving all of the foregoing advantages associated with the conception of the present invention, within a single reaction environment, in addition to providing an additional advantage of temperature control. These features greatly offer wide utility over the prior art catalytic-walled reactors in so far as being easily adapted for use with gaseous, vapor, and liquid reactant streams that contain particulate contaminants without experiencing plugging or excessive pressure drops during operation, over time.

It can also be appreciated from reference to FIG. 3, that an additional advantage associated with the present invention is the relative ease at which the catalytic elements 32 are capable of insertion, removal and replacement with freshly regenerated catalytic mixing elements 32 so that catalytic efficiency is restored to optimal levels during the converting process. Moreover, this feature allows for the use of several of a variety of reactant specific mixing elements 32 positioned in a sequence so that a plurality of chemical reactions occurs in a sequence of chemical reactions to be performed in a continuous process.

While the present invention has been described in connection with the embodiments as described and illustrated above, it will be appreciated and understood by one of ordinary skill in the art that many modifications may be made to the present invention without departing from the true spirit and scope of the invention, as broadly described and claimed herein.

I claim:

1. A catalytic static mixing reactor, comprising:
(a) a conduit casing defined about an axis of a fluid flow;
(b) a first catalyst; and
(c) a static mixing element adapted to be inserted in said conduit wherein said element is formed to obstacle the primary flow inducing a first order mixing phenomenon, said obstacle further formed with at least one irregular surface or edge thereof capable of inducing a second order mixing phenomenon which when coupled with said first order mixing phenomenon allows said element to provide a mixing quality, and wherein said irregular surface is further adapted as a catalytic supporting surface with deposition of the catalyst thereon so that a third order chemical reaction phenomenon is coupled with that of said first and second order mixing phenomenon at the catalyst surface so that a reactant to be converted in the fluid flow is converted to at least one predetermined product during said first and second order mixing phenomenon.

2. The catalytic static mixing reactor according to claim 1, wherein the irregular surface is semi-porous.

3. The catalytic static mixing reactor according to claim 1, wherein in the irregular surface is fibrous.

4. The catalytic static mixing reactor according to claim 1, wherein the irregular surface is a nano-structured sheet or membrane.

5. The catalytic static mixing reactor according to claim 1, wherein the irregular surface includes a nano-tube formation.

6. The catalytic static mixing reactor according to claim 1, wherein the irregular surface further comprises a second catalyst deposited thereon which is capable of converting a second reactant in the fluid flow to a second product.

7. The catalytic static mixing reactor according to claim 6, wherein the second reactant is a product of a first chemical reaction driven by said first catalyst.

8. The catalytic static mixing reactor according to claim 7, wherein said second catalyst is deposited on the element downstream in the fluid flow from the catalyst.
